(19) United States
(12) Patent Application Publication
(10) Pub. No.: US 2017/0006303 A1
(43) Pub. Date: Jan. 5, 2017

(54) METHOD AND SYSTEM OF ADAPTIVE REFERENCE FRAME CACHING FOR VIDEO CODING

(71) Applicant: INTEL CORPORATION, SANTA CLARA, CA (US)

(72) Inventors: RAMANATHAN SETHURAMAN, BANGALORE (IN); SUMIT MOHAN, SAN JOSE, CA (US); HONG JIANG, EL DORADO HILLS, CA (US); JEAN-PIERRE GIACALONE, SOPHIA-ANTIPOLIS (FR)

(21) Appl. No.: 14/788,630

(22) Filed: Jun. 30, 2015

(51) Int. Cl. H04N 19/513; H04N 19/423; H04N 19/179

(52) U.S. Cl. CPC H04N 19/513; H04N 19/179; H04N 19/423

(57) ABSTRACT

Techniques related to adaptive reference frame caching for video coding are described herein.

### BACKGROUND

Due to ever increasing video resolutions, and rising expectations for high quality video images, a high demand exists for efficient image data compression of video while performance is limited for coding with existing video coding standards such as H.264, H.265/HEVC (High Efficiency Video Coding) standards, and so forth. The aforementioned standards use expanded forms of traditional approaches to address the insufficient compression/quality problem, but the results are still insufficient.

Each of these typical video coding systems uses an encoder that generates data regarding video frames that can be efficiently transmitted in a bitstream to a decoder and then used to reconstruct the video frames. This data may include the image luminance and color pixel values as well as intra and inter-prediction data, filtering data, residuals, and so forth that provide lossy compression so that the luminance and color data of each and every pixel in all of the frames need not be placed in the bitstream. Once all of these lossy compression values are established by an encoder, one or more entropy coding methods, which is lossless compression, then may be applied. The decoder that receives the bitstream then reverses the process to reconstruct the frames of a video sequence.

Relevant here, the inter-prediction data may include data to reconstruct reference frames by using motion vectors that indicate the movement of image content between a reference frame and another frame being reconstructed, and from the same sequence of frames. Conventionally, reference frames may be placed in cache during decoding in order to reduce DRAM or main memory bandwidth, reduce power, and improve latency tolerance. When sliding window row cache is implemented, this requires a relatively over-sized L2 cache to capture a sufficient number of the reference frames (such as four) in order to achieve a significant reduction in memory accesses. Alternatively, a decoder may cache in only a single, closest (in position relative to a current frame being analyzed) reference frame in L2 due to capacity limitations, even though multiple reference frames may be used for inter-prediction of a frame being reconstructed, causing a lower hit rate.

### BRIEF DESCRIPTION OF THE DRAWINGS

The material described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is an illustrative diagram of an example encoder for a video coding system;

FIG. 2 is an illustrative diagram of an example decoder for a video coding system;

FIG. 3 is a flow chart of an example method of adaptive reference frame caching for video coding;

FIGS. 4A-B is a detailed flow chart of an example method of adaptive reference frame caching for video coding;

FIG. 5 is a schematic diagram of an example system for adaptive reference frame caching for video coding;

FIGS. 6A-6B are example reference frame binning lists;

FIG. 7 is a schematic diagram of an example system for adaptive reference frame caching for video coding;

FIG. 8 is an illustrative diagram of an example system in operation for a method of adaptive reference frame caching for video coding;

FIG. 9 is an illustrative diagram of an example system;

FIG. 10 is an illustrative diagram of another example system; and

FIG. 11 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, televisions, smart phones, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein also may be implemented as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM) including dynamic RAM (DRAM); magnetic disk storage media; optical storage media; flash memory devices; electrical, optical, acoustical or other forms of propagated signals (e.g., carrier waves, infrared signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as DRAM and so forth.

References in the specification to “one implementation”, “an implementation”, “an example implementation”, etc., indicate that the implementation described may include a particular feature, structure, or characteristic, but every implementation may not necessarily include the particular feature, structure, or characteristic. Moreover, such phrases are not necessarily referring to the same implementation. Furthermore, when a particular feature, structure, or characteristic is described in connection with an implementation, it is submitted that it is within the knowledge of one skilled in the art to effect such feature, structure, or characteristic in connection with other implementations whether or not explicitly described herein.

Systems, articles, and methods are described below related to adaptive reference frame caching for video coding.

Video encoding can utilize multiple reference frames for prediction, dictated by codec level support. During inter-prediction, previously decoded frames in a video sequence of frames may be used as reference frames to reconstruct another frame in the video sequence. An encoder can use a sliding window row cache (L2) for temporarily storing the reference frames utilized to reduce memory bandwidth to an external memory such as double data rate (DDR) DRAM, as well as reduce the accompanying power consumption, and improve latency tolerance. When decoding, if a similar sliding window row cache is utilized, the same memory bandwidth and power consumption can be realized. Specifically, cache is typically located on-board the processor (or has a more direct connection) than other remote memory such as external DRAM so that any hits in the data stored in cache avoids the more costly power and time consuming memory fetch to external DRAM. Sliding window row cache stores data of a frame pixel-by-pixel along a row such as left to right, and then row-by-row down the frame as in raster-fashion.

This conventional arrangement that stores data in sliding window row cache based on codec level support, however, still is relatively inefficient since it requires a relatively larger number of frames to be stored in L2 cache, such as four frames, to obtain a sufficient hit rate. Alternatively, a decoder may be set to only store the closest one or two reference frames in a video sequence of frames in L2 cache in order to maintain a smaller size cache, but this would cause a lower cache hit rate which results in the need for greater bandwidth to DRAM and the resulting rise in power and time consumption.

To resolve these issues, the present adaptive reference frame caching process uses the motion vectors that indicate how image content has moved from frame to frame. Thus, the motion vectors may be used to indicate which frames are reference frames for another frame to be reconstructed in the video sequence. The motion vectors may be obtained before or after pixel coding (motion compensation) at the decoder, and may be used to establish hints that cause reference frames more likely to attain a cache hit to be placed in cache, and by one form L2 cache. By one example form, the motion vectors are used to generate a binning count of how many times a frame is used as a reference frame in one or more reference frame binning tables or lists (also interchangeably referred to herein as motion vector binning tables, MV binning tables, reference frame tables, binning tables, and so forth, or any of these as lists instead of tables) so that it is possible to determine or track the most frequently used reference frame(s) as the hint. Storing the most frequently used reference frames in the L2 cache that better ensures a higher hit rate then enables a reduction in cache size as well as reduction in bandwidth, power and time consumption for memory fetches to external memory such as DRAM.

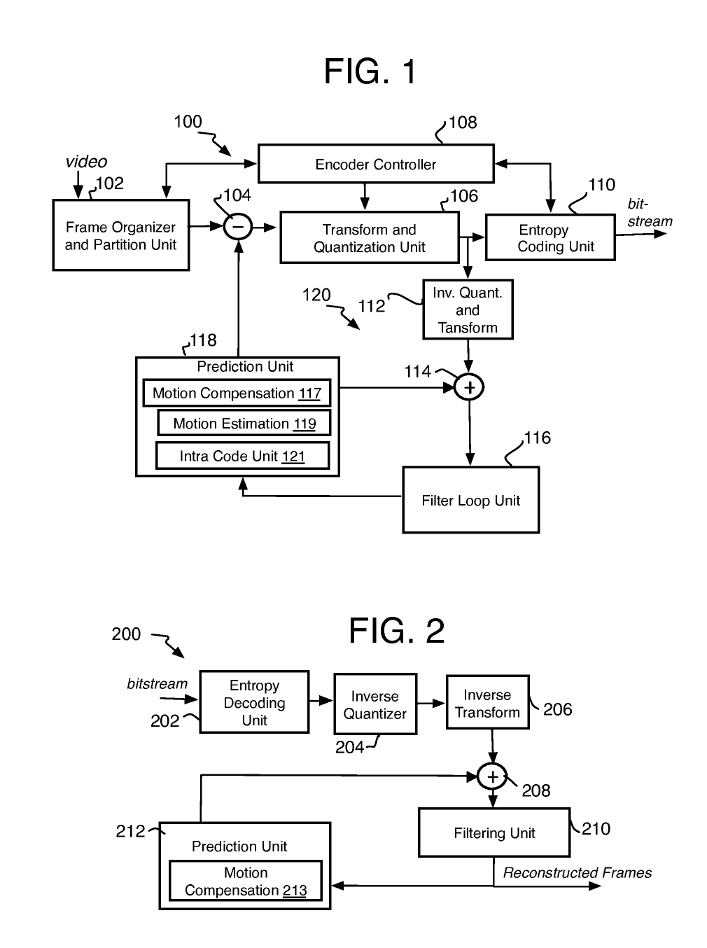

Referring to FIGS. 1-2, to place the method and system of adaptive reference frame caching herein in context, an example, simplified video coding system 100 is arranged with at least some implementations of the present disclosure and that performs inter-prediction using reference frames that may be stored in cache. In various implementations, video coding system 100 may be configured to undertake video coding and/or implement video codecs according to one or more standards. Further, in various forms, video coding system 100 may be implemented as part of an image processor, video processor, and/or media processor and undertakes inter-prediction, intra-prediction, predictive coding, and residual prediction. In various implementations, system 100 may undertake video compression and decompression and/or implement video codecs according to one or more standards or specifications, such as, for example, H.264 (MPEG-4), H.265 (High Efficiency Video Coding or HEVC), but could also be applied to VP9 or other VP#-based standards. Although system 100 and/or other systems, schemes, or processes may be described herein, the features of the present disclosure are not necessarily all always limited to any particular video encoding standard or specification or extensions thereof.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder.

In some examples, video coding system 100 may include additional items that have not been shown in FIG. 1 for the sake of clarity. For example, video coding system 100 may include a processor, a radio frequency-type (RF) transceiver, splitter and/or multiplexor, a display, and/or an antenna. Further, video coding system 100 may include additional items such as a speaker, a microphone, an accelerometer, memory, a router, network interface logic, and so forth.

For the example video coding system 100, the system may be an encoder where current video information in the form of data related to a sequence of video frames may be received for compression. The system 100 may partition each frame into smaller more manageable units, and then compare the frames to compute a prediction. If a difference or residual is determined between an original block and prediction, that resulting residual is transformed and quantized, and then entropy encoded and transmitted in a bitstream out to decoders or storage. To perform these operations, the system 100 may include a frame organizer and partition unit 102, a subtraction unit 104, a transform and quantization unit 106, an entropy coding unit 110, and an encoder controller 108 communicating with and/or managing the different units. The controller 108 manages many aspects of encoding including rate distortion, selection or coding of partition sizes, prediction reference types, selection of prediction and other modes, and managing overall bitrate, as well as others.

The output of the transform and quantization unit 106 also may be provided to a decoding loop 120 provided at the encoder to generate the same reference or reconstructed blocks, frames, or other frame partitions as would be generated at the decoder. Thus, the decoding loop 120 uses inverse quantization and transform unit 112 to reconstruct the frames, and adder 114 along with other assembler units not shown to reconstruct the blocks within each frame. The decoding loop 120 then provides a filter loop unit 116 to increase the quality of the reconstructed images to better match the corresponding original frame. This may include a deblocking filter, a sample adaptive offset (SAO) filter, and a quality restoration (QR) filter. The decoding loop 120 also may have a prediction unit 118 with a decoded picture buffer to hold reference frame(s), and a motion estimation 119 and motion compensation unit 117 that uses motion vectors for inter-prediction, and intra-frame prediction module 121. Intra-prediction or spatial prediction is performed on a single I-frame without reference to other frames. The result is the motion vectors and predicted blocks (or coefficients).

In more detail, and relevant here, the motion estimation unit 119 uses pixel data matching algorithms to generate motion vectors that indicate the motion of image content between one or more reference frames and the current frame being reconstructed. The motion vectors are then applied by the motion compensation unit 117 to reconstruct the new frame. The adaptive reference frame caching technique described below could be used to reconstruct the frames here at the encoder as well as the decoder. In the encoder case, the identification of the reference frames may be determined from the motion vectors after the motion vectors are generated by the motion estimation unit 119 and before application by the motion compensation unit 117. Thus, while many of the operations below describe the technique used with the decoder, it will be understood that the encoder could also implement the reference frame caching techniques described herein for the motion compensation at the prediction loop of the encoder. Then, the prediction unit 118 may provide a best prediction block both to the subtraction unit 104 to generate a residual, and in the decoding loop to the adder 114 to add the prediction to the residual from the inverse transform to reconstruct a frame. Other modules or units may be provided for the encoding but are not described here for clarity.

More specifically, the video data in the form of frames of pixel data may be provided to the frame organizer and partition unit 102. This unit holds frames in an input video sequence order, and the frames may be retrieved in the order in which they need to be coded. For example, backward reference frames are coded before the frame for which they are a reference but are displayed after it. The input picture buffer may also assign frames a classification such as I-frame (intra-coded), P-frame (inter-coded, predicted from a previous reference frame), and B-frame (inter-coded frame which can be bi-directionally predicted from previous frames, subsequent frames, or both). In each case, an entire frame may be classified the same or may have slices classified differently (thus, an I-frame may include only I slices, P-frame can include I and P slices, and so forth. In I slices, spatial prediction is used, and in one form, only from data in the frame itself. In P slices, temporal (rather than spatial) prediction may be undertaken by estimating motion between frames. In B slices, and for HEVC, two motion vectors, representing two motion estimates per partition unit (PU) (explained below) may be used for temporal prediction or motion estimation. In other words, for example, a B slice may be predicted from slices on frames from either the past, the future, or both relative to the B slice. In addition, motion may be estimated from multiple pictures occurring either in the past or in the future with regard to display order. In various implementations, motion may be estimated at the various coding unit (CU) or PU levels corresponding to the sizes mentioned below. For older standards, macroblocks or other block basis may be the partitioning unit that is used.

Specifically, when an HEVC standard is being used, the prediction partitioner unit 104 may divide the frames into prediction units. This may include using coding units (CU) or large coding units (LCU). For this standard, a current frame may be partitioned for compression by a coding partitioner by division into one or more slices of coding tree blocks (e.g., 64×64 luma samples with corresponding chroma samples). Each coding tree block may also be divided into coding units (CU) in quad-tree split scheme. Further, each leaf CU on the quad-tree may either be split again to 4 CU or divided into partition units (PU) for motion-compensated prediction. In various implementations in accordance with the present disclosure, CUs may have various sizes including, but not limited to 64×64, 32×32, 16×16, and 8×8, while for a 2N×2N CU, the corresponding PUs may also have various sizes including, but not limited to, 2N×2N, 2N×N, N×2N, N×N, 2N×0.5N, 2N×1.5N, 0.5N×2N, and 1.5N×2N. It should be noted, however, that the foregoing are only example CU partition and PU partition shapes and sizes, the present disclosure not being limited to any particular CU partition and PU partition shapes and/or sizes.

As used herein, the term “block” may refer to a CU, or to a PU of video data for HEVC and the like, or otherwise a 4×4 or 8×8 or other rectangular shaped block. By some alternatives, this may include considering the block as a division of a macroblock of video or pixel data for H.264/AVC and the like, unless defined otherwise.

The current blocks may be subtracted from predicted blocks from the prediction unit 118, and the resulting difference or residual is partitioned as stated above and provided to a transform and quantization unit 106. The relevant block or unit is transformed into coefficients using discrete cosine transform (DCT) and/or discrete sine transform (DST) to name a few examples. The quantization then uses lossy resampling or quantization on the coefficients. The generated set of quantized transform coefficients may be reordered and then are ready for entropy coding. The coefficients, along with motion vectors and any other header data, are entropy encoded by unit 110 and placed into a bitstream for transmission to a decoder.

Referring to FIG. 2, an example, simplified system 200 may have, or may be, a decoder, and may receive coded video data in the form of a bitstream. The system 200 may process the bitstream with an entropy decoding unit 202 to extract quantized residual coefficients as well as the motion vectors, prediction modes, partitions, quantization parameters, filter information, and so forth. Relevant here, the bitstream includes the motion vectors, coefficients, and other header data for inter-prediction and to be entropy decoded.

The system 200 then may use an inverse quantization module 204 and inverse transform module 206 to reconstruct the residual pixel data. Thereafter, the system 200 may use an adder 208 to add assembled residuals to predicted blocks to permit rebuilding of prediction blocks. These blocks may be passed to the prediction unit 212 for intra-prediction, or first may be passed to a filtering unit 210 to increase the quality of the blocks and in turn the frames, before the blocks are passed to the prediction unit 212 for inter-prediction. For this purpose, the prediction unit 212 may include a motion compensation unit 213 to apply the motion vectors. As explained in detail below, the motion vectors may be used to identify reference frames either before or after the motion compensation unit 213 applies the motion vectors to reconstruct a frame and depending on whether the system can extract motion vectors before the frame reconstruction (or in other words, directly from the entropy decoded stream) or the motion vectors are obtained from the motion compensation unit 213 after a frame is reconstructed as explained below. The motion compensation unit 213 may use at least one L1 cache to store single frame portions and/or perform compensation algorithms with the motion vectors, and use at least one L2 cache to store the most frequently used reference frames also as described in detail below. The prediction unit 212 may set the correct mode for each block or frame before the blocks or frames are provided to the adder 208. Otherwise, the functionality of the units described herein for systems 100 and 200 are well recognized in the art and will not be described in any greater detail herein.

For one example implementation, an efficient adaptive reference frame caching process is described as follows.

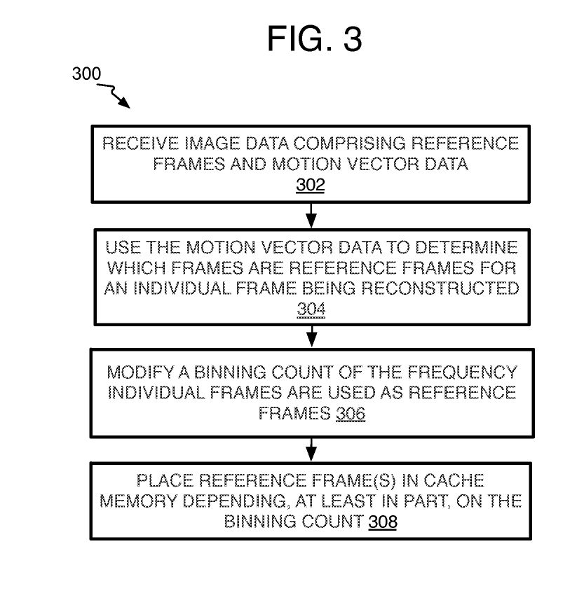

Referring to FIG. 3, a flow chart illustrates an example process 300, arranged in accordance with at least some implementations of the present disclosure. In general, process 300 may provide a computer-implemented method of adaptive reference frame caching for video coding. In the illustrated implementation, process 300 may include one or more operations, functions or actions as illustrated by one or more of operations 302 to 308 numbered evenly. By way of non-limiting example, process 300 may be described herein with reference to operations discussed with respect to FIGS. 1-2, 5-7 and 9 with regard to example systems 100, 200, 500, 600, 700, or 900 discussed herein.

The process 300 may comprise “receive image data comprising reference frames and motion vector data” 302, and as understood, the image data may be whatever data may be needed to reconstruct video frames using inter-prediction at least including data of frames to be used as reference frames, and motion compensation data to reconstruct the frames using motion vectors. At the decoder, the bitstream may be received in a state that requires entropy decoding as explained above.

The process 300 also may include “use the motion vector data to determine which frames are reference frames for an individual frame being reconstructed” 304. Also as mentioned, since a motion vector indicates the change in position of image content (or chroma or luminance pixel data) from one frame to another frame in a video sequence of frames, the motion vector indicates which frames are the reference frames for another frame. When motion vectors are accessible from the entropy decoded bitstream and prior to pixel decoding, the motion vectors may be used to determine which frames in the video sequence being decoded are reference frames for a current frame about to be reconstructed. When the motion vectors are not available directly from the entropy decoded data and available only after pixel decoding, then the motion vectors may be used to determine which frames in the video sequence being decoded are reference frames for a next frame about to be reconstructed.

The process 300 also may include “modify a binning count of the frequency individual frames are used as reference frames” 306. As described in detail below, this may include using one or more reference frame or motion vector binning lists or tables. By one form, the binning table(s) has bins for a certain number of consecutive frames both before and after a current frame being reconstructed and within the video sequence. Each time a frame is identified as a reference frame by motion vectors, the bin associated with that frame has its count incremented up by one. By one example, there are two binning tables, one table for frames before the current frame and another table for frames after the current frame. By one example, there are 16 frames in each table although there can be more or less.

The process 300 also may include “place reference frame(s) in cache memory depending, at least in part, on the binning count” 308, and this may include placing a predetermined number of reference frames, such as one or two, in the L2 cache that have the greatest count in the table(s). Thus, by one example, precise reference frame identification for a single current frame is sacrificed for the relatively long term and more efficient placement of the most frequently used reference frames into the cache L2.

As it will be understood, once a reference frame is placed in cache, the motion compensation unit can use the data of the reference frame coupled with the motion vectors to reconstruct the current frame. It also will be understood that when the motion vectors and reference frame identification could not be obtained until after the associated current frame is reconstructed, the identified reference frames are used to place the most frequently used reference frames in cache for reconstruction of the next frame relying on the assumption that two consecutive frames typically have relatively small differences in pixel data. For relatively large changes in frame data, such as in the first frame in a new scene or other I-frames, the frames are treated differently as explained below.

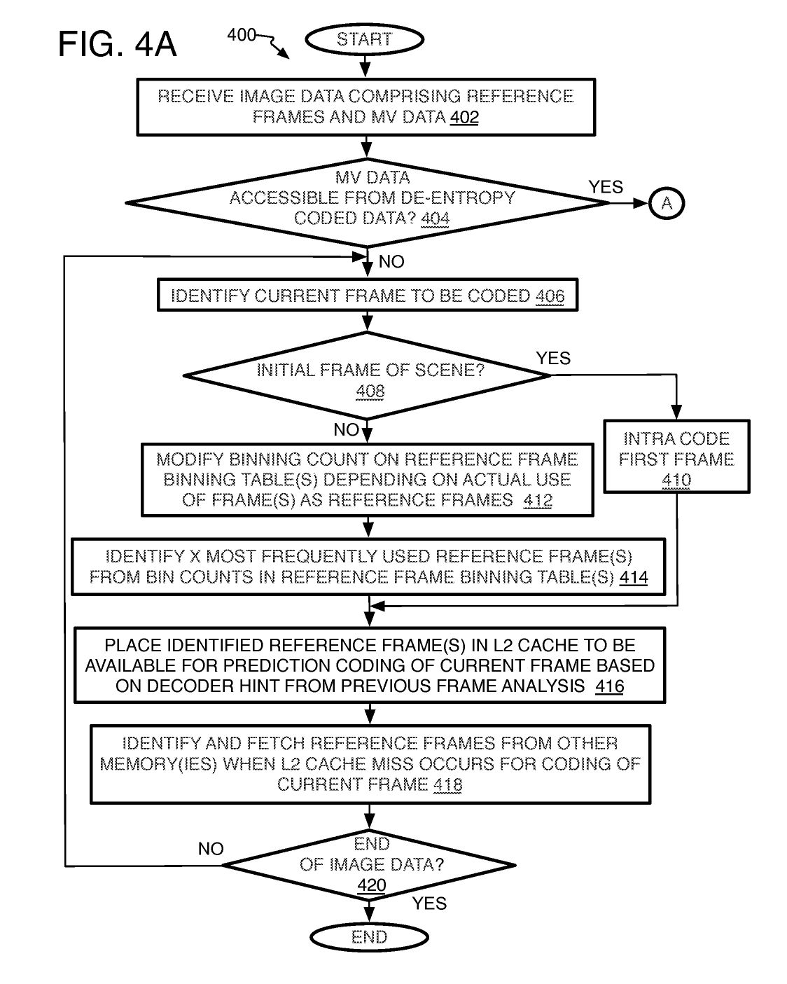

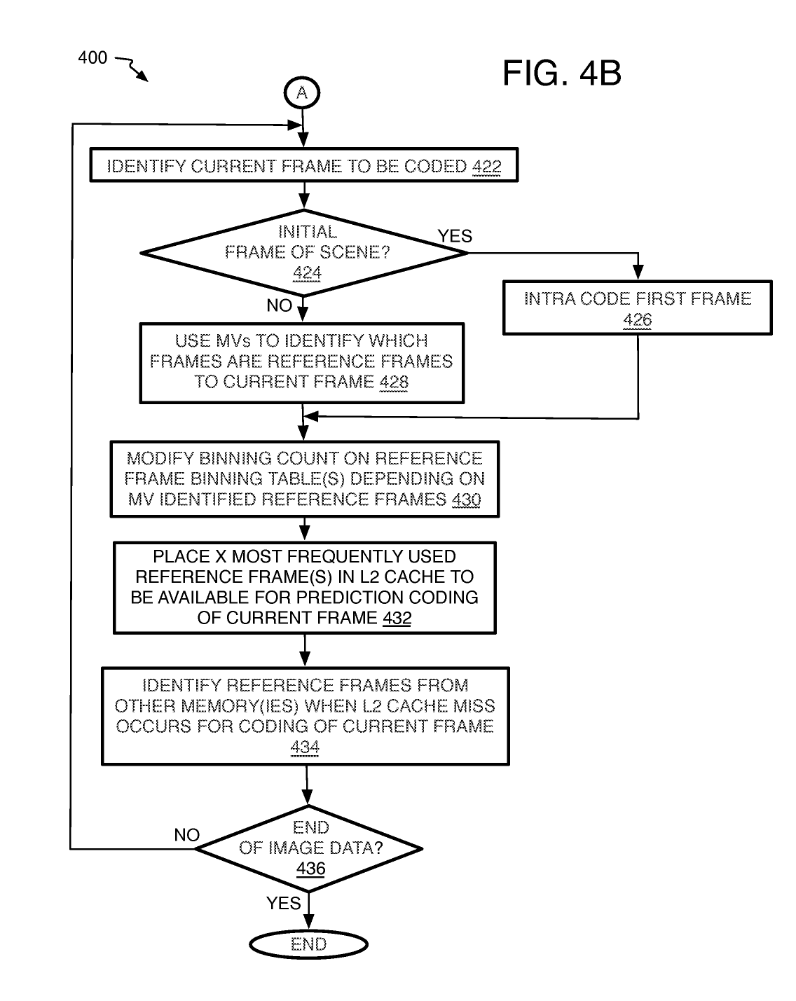

Referring now to FIGS. 4A-4B, a detailed example adaptive reference frame caching process 400 is arranged in accordance with at least some implementations of the present disclosure. In the illustrated implementation, process 400 may include one or more operations, functions or actions as illustrated by one or more of operations 402 to 436 numbered evenly. By way of non-limiting example, process 400 will be described herein with reference to operations discussed with respect to FIGS. 1-2, 5-7, and 9, and may be discussed with reference to example systems 100, 200, 500, 600, 700, and/or 900 discussed herein.

Process 400 may include “receive image data comprising reference frames and my data” 402, and as explained above, this includes pixel data of frames in a video sequence that may be used as reference frames, and particularly the luminance and chroma data, as well as motion vectors that indicate the motion of the image content between frames. It will be understood that the motion vector data on the decoder side may be obtained after entropy decoding and prior to pixel decoding or after pixel decoding depending on availability of (hardware) hooks. Alternatively, the motion vectors on the encoder side may be obtained directly from a motion estimation unit generating the motion vectors in the coding loop. The motion vectors may include a source pixel, block, or other data area on a location on one frame and a distance and direction of displacement for placement of the data on another frame. The format of the motion vector data is not particularly limited as long as it indicates a source frame as a reference frame and a destination frame to be reconstructed.

Process 400 may include “my data accessible from de-entropy coded data?” 404, which is a test to determine whether the motion vectors are available directly after entropy decoding of the image data. If so, then reference frames for the current frame about to be reconstructed by a motion compensation unit may be cached in L2 based on the updated binning count for a current frame. If not, the reference frame identification may be obtained after motion compensation of a current or individual frame, and the binning count is modified to determine which reference frames to put into cache for the next frame to be reconstructed as explained in greater detail below.

For reasons such as lack of (hardware) hooks to extract motion vectors post entropy decoding and before pixel decoding, motion vectors may not be available for binning purposes for current frame caching. In this case, the reference frame identification may be obtained after motion compensation of a current or individual frame, and the binning count is modified to determine which reference frames to put into cache for the next frame decoding. In contrast, availability of (hardware) hooks to extract motion vectors post entropy decoding and before pixel decoding allows the reference frames for the current frame about to be reconstructed by a motion compensation unit to be cached in L2 based on the updated binning count for the current frame.

When the motion vectors cannot be obtained from the entropy decoded data and before motion compensation is applied, process 400 may include “identify current frame to be coded” 406, and in particular, identify which frame is now the current frame to be reconstructed.

Process 400 then may include “initial frame of scene?” 408, and it is determined whether the current frame is the first frame in a scene. When this is the case, process 400 may include “intra code first frame” 410. If the current frame is the first frame in a scene, or is otherwise an intra-coded I-frame, the binning operations are skipped, and the current frame is intra coded without using reference frames.

By another alternative, the system may be adaptable so that if the L2 cache hits drop below a predetermined percentage or other criterion, or if many more reference frames are used to reconstruct a single frame such that the cache hit will be low anyway (such as when four or more reference frames are used for a single frame when the L2 cache only holds one reference frame), the binning and hints may be omitted in these cases as well. By one example, when the cache hits drop below 50%, the reference frame binning tables are not used.

If the current frame is not the first frame in a scene (or otherwise the MV binning and hinting has been initiated), process 400 may include “modify binning count on reference frame binning table(s) depending on actual use of frame(s) as reference frames” 412. In other words, the decoder tracks reference frame usage during motion compensation by noting which frame or frames are used as reference frames for the previous frame being reconstructed. When a reference frame was used, the frame count on a binning table is incremented by one, and such as by an MV binner unit.

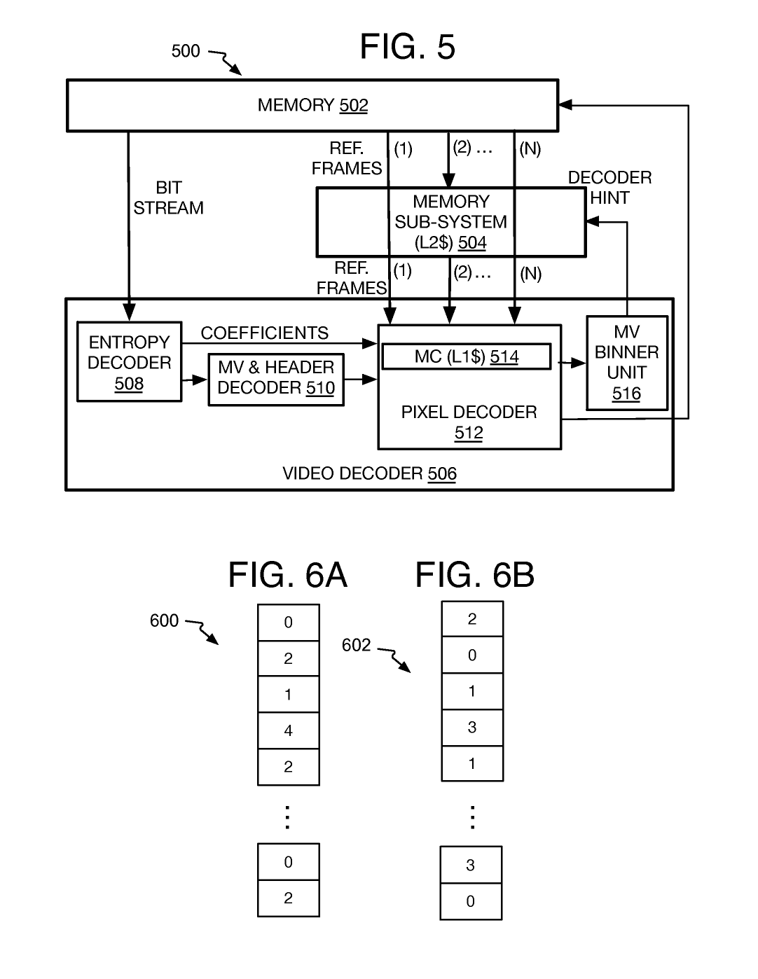

Referring to FIG. 5 as one decoder example, a system 500 has one or more memories 502, such as RAM, DRAM, or DDR DRAM, or other temporary or permanent memory that receives and stores entropy encoded image data as well as decoded frames. The system 500 also may have a memory sub-system 504 with L2 cache, and a decoder 506 with an entropy decoder 508, an MV and header decoder 510, a pixel decoder (or motion compensation unit) 512 that has a cache L1 514, and an MV binner unit 516. The image data is entropy decoded and then MVs may be decoded by the unit 510. In this example, however, the MVs cannot easily be extracted from the data and is limited to use by the pixel decoder 512. The pixel decoder 512 uses the motion vectors and a previously decoded frame or frames now being used as reference frames to determine the motion of the image data from the reference frames to the new frame being reconstructed. Thus, the pixel decoder 512 used the motion vectors to identify the reference frames and then fetch the reference frames from L2 cache or other memory as needed. This is shown by reference frames (1) to (N) on FIG. 5 where reference frames (1) and (N) are obtained from memory 502 and reference frame (2) is placed in cache L2 based on decoder hint from previous frame analysis, and then obtained from cache L2 by the pixel decoder 512. The pixel decoder 512 also may have at least one L1 cache to store single reference frame portions to attempt to obtain a first cache hit on a reference frame, and/or use the L1 cache to perform compensation algorithms with the motion vectors. Once a frame is reconstructed, it is stored back in the memory 502 or other memory, and the motion vectors that were used for the reconstruction are now accessible (or may be determined), which in turn will indicate which frames were used as the reference frames for the reconstruction. These motion vectors that indicate the source reference frames are then provided to the MV binner unit 516 which then determines the decoder hint for next frame to be cached by L2.

Referring to FIGS. 6A-6B, the MV binner unit 516 uses the MVs to determine the reference frame identifications, and increments the bin for each reference frame by one on the reference frame or motion vector binning tables. By the illustrated example, there may be one list or table 600 to hold bins for the counts of consecutive frames that may be used as reference frames and positioned before a current frame being reconstructed along the video sequence (backward prediction), and another table 602 to hold the bins for consecutive frames that may be used as reference frames after the position of the current frame being reconstructed (forward prediction). Although these may be consecutive frame positions as mentioned, this need not always be so. Also, in this example, there may be 16 bins for 16 frames on each list, although any other number of bins found to be efficient may be used. Random example numbers represent binning counts shown in the bins but it will be appreciated that the counts remain in binary or other form rather than decimal numbers. It will also be appreciated that the system may use bin number labels (1 to 16) for each list in order to find the correct bin but that these label numbers need not be coded and are inherent in the position of the bin along the table. The tables also may be stored in the memory 502 or other memory that has the capacity to maintain the table throughout a scene.

The MV binner unit 516 modifies the tables 600 and 602 based on the MVs per macro block for backward prediction (600) and forward prediction (602). For example, the motion vectors per macro block for backward prediction might refer to frame number 4 from current frame being reconstructed more often and may generate a high binning count (bin count 4), while the motion vectors per macro block for forward prediction might refer to frame numbers 4 and 15 from current frame being reconstructed more often and may generate a high binning count (bin count 3).

For each frame being processed, using the MVs per macro block, the MV binner unit 516 bins into backward prediction (600) and forward prediction (602) tables, always starting with reinitialized bin count of zero for all positions in the bin tables.

Near the beginning of the scene, when there are few reference frames with bin counts, the system may initially place the closest reference frame to the frame being reconstructed in the video sequence, and into the L2 cache. This may occur for just the second frame on a scene or more frames.

Otherwise, process 400 may include “identify X most frequently used reference frame(s) from bin counts in reference frame binning table(s)” 414. After frame decode, the reference frame usage is analyzed by searching the bins for the most frequently used frame(s), which may be the maximum values in the bins. This may be a single reference frame for all of the bins on all of the tables. By another example, the most frequently used frame on each table (the preceding or past reference frames on one table 600 pertaining to backward prediction, and subsequent or future reference frames on another table 602 pertaining to forward prediction) are selected for B-frames for example. Otherwise, a predetermined number of reference frames (such as 2 to 4) are selected, and may be evenly split upon the two or more tables, or may be selected no matter which table the most frequently used reference frames are on. On the other hand, P-frames may be limited to the preceding reference frame table bins.

Process 400 may include “place identified reference frame(s) in L2 cache to be available for prediction coding of current frame based on decoder hint from previous frame analysis” 416. Thus, the image data of the one to two reference frames identified as the most frequently used reference frames are placed in the L2 cache. For IBBP group of pictures (GOP) sequence, the L2 cache may include the most frequently used two reference frames. Even when four reference frames are used equally, the L2 cache still may merely cache pixels from two reference frames. This may vary depending on the scene.

The pixel decoder then may apply the motion vectors and use the reference frames in the L2 cache to reconstruct the current frame based on decoder hint from previous frame analysis. In other words, reference frames are determined for a previous frame being reconstructed, these identified frames are then used to modify the bin count and determine the most frequently used reference frames on the binning tables. Then, these most frequently used reference frames are placed in the L2 cache to be used to reconstruct the current frame in the video sequence.

The pixel decoder may search for the reference frames in the L2 cache, but if the fetch in the L2 cache results in a miss, or when there are more reference frames for a current frame than reference frames in the L2 cache, the process 400 may include “identify and fetch reference frames from other memory(ies) when L2 cache miss occurs for coding of current frame” 418. Thus, the pixel decoder may attempt to fetch reference frames from DRAM or other memory.

Process 400 may include “end of image data?” 420, and particularly to determine if there are more image data frames to be reconstructed. If so, the process loops to operation 406 to identify the next current frame to be coded. If not, the process ends and the decoded frames may be placed in storage or used for display.

If the motion vectors are available from the entropy decoded data, such as when frame level entropy coding is used, the motion vectors may be parsed from the data before pixel decoding (or motion compensation) occurs, and the motion vectors may be used to determine reference frames for a current frame about to be reconstructed. In this case, process 400 may include “identify current frame to be coded” 422, a test to determine whether the current frame is the “initial frame of scene?” 424, and then if so, to “intra code first frame” 426, all similar to operations 406, 408, and 410 of process 400 when the motion vectors are obtained after pixel decoding.

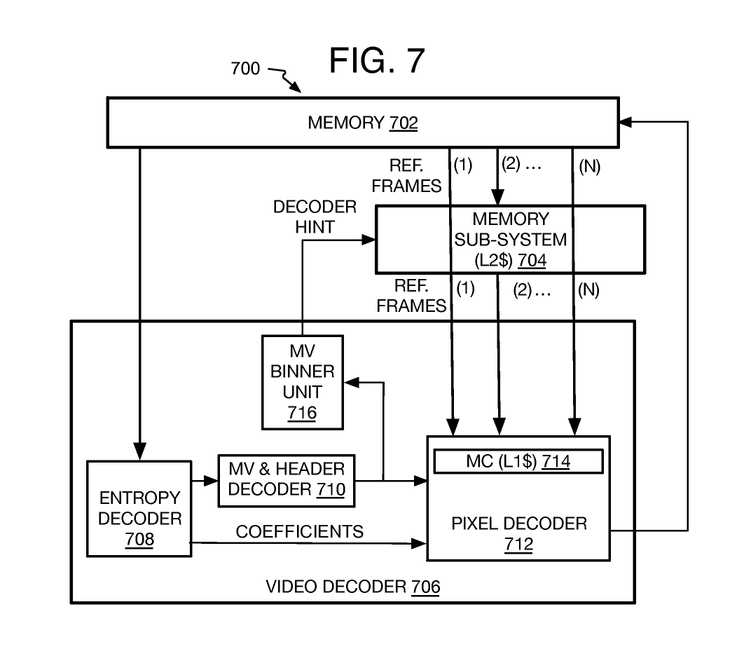

Here, however, process 400 then may include “use MVs to identify which frames are reference frames to current frame” 428. Referring to FIG. 7 as an example to assist with explaining this portion of process 400, a system 700 may be similar to system 500 (FIG. 5) where similar components are numbered similarly and do not need separate explanation except that in this case, the MV binner unit 716 receives motion vectors extracted from the image data after the MV & header decoder 710 decodes the motion compensation data but before the current frame associated with the motion compensation data including the motion vectors is reconstructed by the pixel decoder 712. As explained above, the motion vectors indicate which frames are reference frames for the current frame, except here the current frame is yet to be reconstructed.

Thereafter, process 400 may include “modify binning count on reference frame binning table(s) depending on MV identified reference frames” 430. Thus, the count in the bins of the reference frame tables 600 and 602 are incremented upward one for each bin associated with a frame indicated as a reference frame by the motion vectors for the current frame to be reconstructed.

Process 400 may include “place X most frequently used reference frame(s) in L2 cache to be available for prediction coding of current frame” 432, and as already explained above for similar operations 414 and 416, except here the L2 cache now has the most frequently used reference frames for the current frame about to be reconstructed instead of the reference frames for the previous frame already reconstructed.

Process 400 may include “identify reference frames from other memory(ies) when L2 cache miss occurs for coding of current frame” 434, and “end of image data?” 436, both of which are already explained with similar operations 418 and 420 above. In the present example, if the video sequence is not complete, the process 400 loops back to operation 422 to identify the next current frame to be reconstructed.

The following results are obtained by using the adaptive reference frame caching processes described herein. An average distribution of coded blocks is found to be as follows:

TABLE 1

| | I-Frame | P-Frame | B-Frame |
|---|---|---|---|
| Intra | 100% | 15% | 15% |
| Skip | 0% | 15% | 15% |
| P 1-Ref. | 0% | 70% | 30% |
| Bi or P 2-Ref. | 0% | 0% | 40% |

Table 1 shows the typical prediction method used for reconstruction and the reference frame distribution by frame type. Thus, for example, 15% of P-frames and B-frames are intra coded, 15% of the frames are skipped altogether, while 70% of P-frames are reconstructed using a single reference frame while only 30% of B-frames are reconstructed with a single reference frame and 40% of B-frames are reconstructed using two reference frames. With the known reconstruction distribution, it is possible to determine the usage of the reference frame tables. Specifically, average distribution of selecting reference frames from tables 600 or 602 (also labeled here as list 0 and 1) or from both tables (Bi) is as follows:

TABLE 2

| | |
|---|---|
| List 0 | 57% |
| List 1 | 10% |
| Bi | 33% |
| Total | 100% |

where each list 0 and 1 has 16 bins, and list 0 has 16 consecutive frames before (preceding or past) the current frame being reconstructed and list 1 has 16 consecutive frame after (subsequent or future) to the current frame and along the video sequence in display order. With this data, it was possible to determine from measured data that the average stripe cache (L2) hit percentage is as follows:

TABLE 3

| Decoder Hint | List 0/1 best 1-ref hint | List 0/1 best 2-ref hint |
|---|---|---|
| HIT Percentage | 74% | 95% |

where stripe cache uses a search in the cache by using a window that fits across the entire row of a frame and includes a number of rows, such as 16 or more rows, and the stripe or window is traversed downward over the frame to search different rows from the top to the bottom of the frame for example.

Other benefits of attaining this relatively high L2 cache hit by using decoder hints to cache the correct reference frames from list 0 and 1 is as follows.

First, decode bandwidth savings for 4k60 screen size are to be:

TABLE 4

| | Expected Resulting |
|---|---|
| | Bandwidth (measured |
| | as reference frame |
| | fetches from DDR |
| Reference Frame Hint Usage | DRAM in GB/s) |
| Conventional methodology without hints | 1.38 GB/s |
| (no L2 Cache (0 Reference hints)) | |
| L2 cache using only 1-Reference decoder hints | 0.98 GB/s |
| L2 cache using only 2-Reference decoder hints | 0.88 GB/s |

Thus, the total decode bandwidth savings expected is 29% bandwidth reduction with L2 only caching 1-Ref., and 36% bandwidth reduction with L2 caching 2-Ref. It should be noted that the conventional 0-Ref hint used for comparison is the best codec data for media IP that has an internal L1 cache.

In summary, the above tables highlight the advantage of the proposed solution with decoder hints compared to the solution without decoder hints. The proposed solution offers reduced bandwidth to DDR DRAM (up to about 36% less bandwidth).

With regards to the resulting reduction in L2 cache size, for a 4kp60 HEVC 32×32 LCU with +/−48 pixel search-range of encoded video content, one example of the required memory to maintain a sufficient cache hit rate is as follows:

TABLE 5

| 4k60 | w/o decoder hint | w/decoder hint |
|---|---|---|
| L2 | (48*2 + 32)*4k*1.5*4 = 3 MB | (48*2 + 32)*4k*1.5*1 = .75 MB |
| Cache | (4 ref. frames L2 cached) | (1 ref. frame L2 cached) |
| Size | | (48*2 + 32)*4k*1.5*2 = 1.5 MB |
| | | (2 ref. frames L2 cached) |

resulting in a 50% or even 75% reduction in required L2 cache size.

In addition to the DDR DRAM bandwidth savings and L2 cache size reduction, the decoder hint solution approach results in more latency tolerance since significantly more of the requests from the video decoder IP (with L1) will be met by L2 due to a high stripe cache hit. In other words, since the L2 cache hits will be significantly more frequent resulting in very significant time savings due to fewer DRAM fetches, the time savings can be used for other reference frame fetches from the DDR DRAM or other tasks. This will thereby reduce the latency impact of accessing DDR in a significant way.

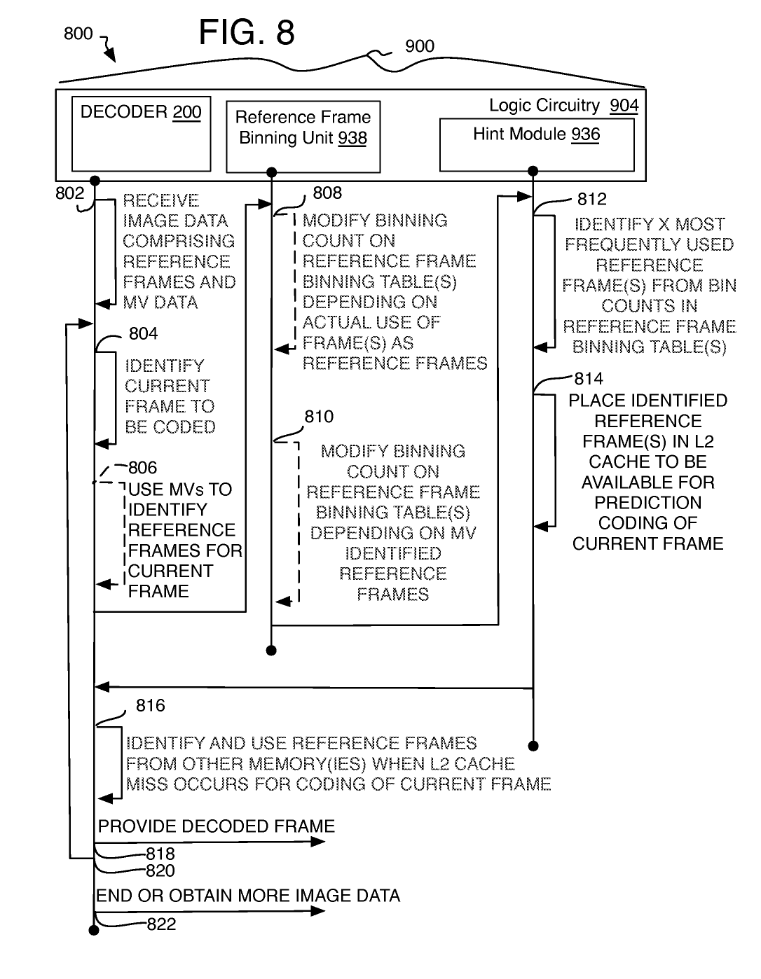

Referring now to FIG. 8, system 900 may be used for an example adaptive reference frame caching process 800 for video coding shown in operation, and arranged in accordance with at least some implementations of the present disclosure. In the illustrated implementation, process 800 may include one or more operations, functions, or actions as illustrated by one or more of actions 802 to 822 numbered evenly, and used alternatively or in any combination. By way of non-limiting example, process 800 will be described herein with reference to operations discussed with respect to any of the implementations described herein.

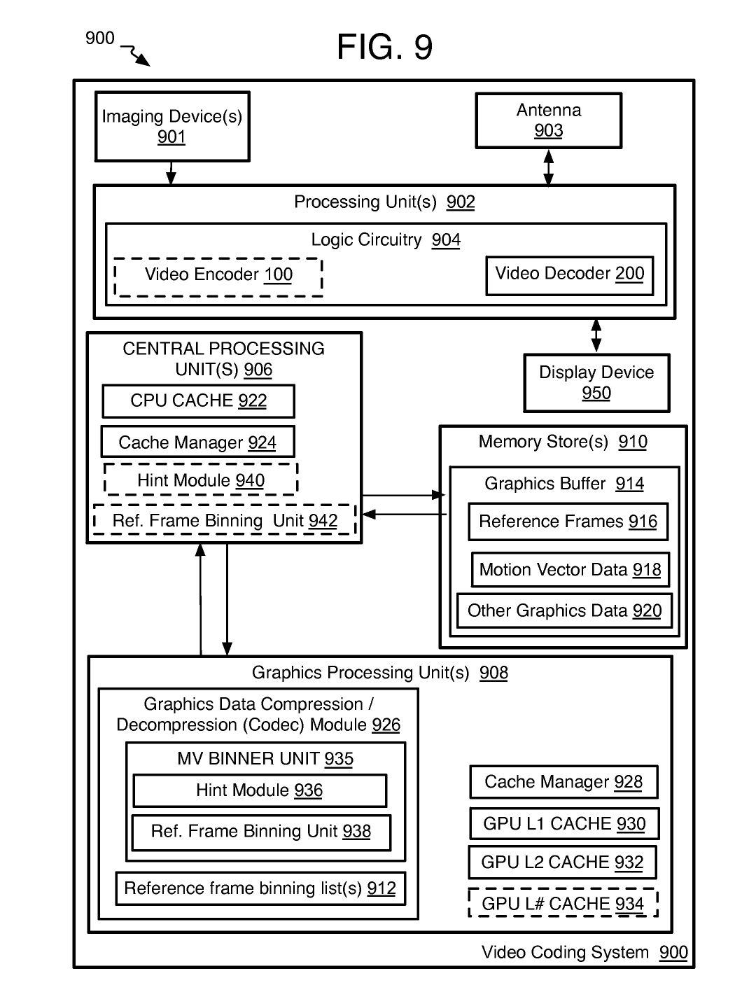

In the illustrated implementation, system 900 may include a processing unit 902 with logic units or logic circuitry or modules 904, the like, and/or combinations thereof. For one example, logic circuitry or modules 904 may include the video decoder 200 and/or video encoder 100 either with inter-prediction functionality. Also, the system 900 may have a central processing unit or graphics processing unit as shown here with a graphics data compression and/or decompression (codec) module 926. Relevant here, the graphics module 926 may have an MV binner unit 935 with a hint module 936 and a reference frame binning unit 938. Reference frame binning list(s) or tables 912 may be held on-board the graphics processing unit 908 or stored elsewhere on the system. The system also may use other memory 910, such as DRAM or other types of RAM or temporary memory, to at least store a graphics buffer 914 holding reference frames 916, motion vector data 918, and other graphics data 920 including coefficients and/or other overhead data. The graphics unit 908 also may have a cache manager 928, and at least L1 and L2 cache memory locations 932 and 934 where the L2 cache may be uploaded via the use of the MV binner unit 935. Although system 900, as shown in FIG. 9, may include one particular set of operations or actions associated with particular modules or units, these operations or actions may be associated with different modules than the particular module or unit illustrated here.

Process 800 may include “receive image data comprising reference frames and MV data” 802, and “identify current frame to be coded” 804, and as already explained above with process 400.

Process 800 may include “use MVs to identify reference frames for current frame” 806, and where the entropy coding is performed on a frame level or are otherwise accessible, the motion vectors are parsed from the entropy decoded bitstream (when at the decoder rather the decoding loop of the encoder) before pixel coding (or in other words, motion compensation). Alternatively, when the entropy coding is performed on a codec level, the pixel coding is performed first on a current frame, and then the motion vectors that were actually used to reconstruct the current frame are obtained.

Process 800 may include “modify binning count on reference frame binning table(s) depending on actual use of frame(s) as reference frames” 808. Particularly, when the motion vectors are obtained after pixel coding, the counts in the bins of the reference frame binning tables, as described above, are modified according to which reference frames were used to reconstruct the current (or now actually the previous) frame. This includes reference frames indicated by the motion vectors no matter where those reference frames were stored and fetched from. Thus, the reference frames are counted regardless of whether the reference frame was found in L2 cache, RAM, or other memory.

Alternatively, process 800 may include “modify binning count on reference frame binning table(s) depending on MV identified reference frames” 810. Thus, for motion vectors obtained before pixel coding, the motion vectors indicate the reference frames that are going to be used to reconstruct the current frame. In this case, the count in the bins of the reference frame binning table(s) are modified as described above and according to the indicated reference frames. Again, it does not matter where the reference frames were stored to be included in the count on the reference frame binning tables, it only matters here that the reference frames were indicated for use by the motion vectors.

Process 800 may include “identify X most frequently used reference frame(s) from bin counts in reference frame binning table(s)” 812. Thus, by one example form, regardless of whether the motion vectors identify the actual reference frames yet to be used to reconstruct a current frame, this operation still selects the most frequently used reference frames from the binning table(s) to be placed in L2 cache. As mentioned above, this is to better ensure long term L2 cache hit accuracy and efficiency during a video sequence or scene even though it may sacrifice L2 cache hit accuracy for a number of single frames in the video sequence.

Process 800 may include “place identified reference frame(s) in L2 cache to be available for prediction coding of current frame” 814. Thus, by one form, the one, two, or other specified number X of most frequently used reference frames are placed in the L2 cache.

Process 800 may include “identify and use reference frames from other memory(ies) when L2 cache miss occurs for coding of current frame” 816. This operation includes the performance of the reconstruction coding of a current frame by the motion compensation unit (or pixel decoder) which includes fetching the reference frames from L2 cache when needed, and that are identified by the motion vectors. If a miss occurs, the system then looks elsewhere for the reference frames, such as in the DDR DRAM or other memory.

Process 800 then may include “provide decoded frame” 818 when the decoding of the current frame is complete. Process 800 then may include looping 820 back to operation 804 to reconstruct the next current frame. Otherwise, if the end of the image is reached, process 800 may include “end or obtain more image data” 822.

While implementation of example process 300, 400, and/or 800 may include the undertaking of all operations shown in the order illustrated, the present disclosure is not limited in this regard and, in various examples, implementation of any of the processes herein may include the undertaking of only a subset of the operations shown and/or in a different order than illustrated.

In implementations, features described herein may be undertaken in response to instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more features described herein in response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the features described herein. As mentioned previously, in another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as DRAM and so forth.

As used in any implementation described herein, the term “module” refers to any combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any combination of firmware logic and/or hardware logic configured to provide the functionality described herein. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be implemented via a software module, which may be embodied as a software package, code and/or instruction set, and also appreciate that a logic unit may also utilize a portion of software to implement its functionality.

Referring to FIG. 9, an example video coding system 900 for adaptive reference frame caching may be arranged in accordance with at least some implementations of the present disclosure. In the illustrated implementation, system 900 may include one or more central processing units or processors 906, an imagining device(s) 901 to capture images, an antenna 903, a display device 950, and one or more memory stores 910. Central processing units 906, memory store 910, and/or display device 950 may be capable of communication with one another, via, for example, a bus, wires, or other access. In various implementations, display device 950 may be integrated in system 900 or implemented separately from system 900.

As shown in FIG. 9, and discussed above, the processing unit 902 may have logic circuitry 904 with an encoder 100 and/or a decoder 200. The video encoder 100 may have a decoding loop with a pixel decoder or motion compensation unit, and the decoder 200 may have a pixel decoder or motion compensation unit, as well as other components as described above. Further, either CPU 906 or a graphics processing unit 908 may have a graphics data compression and/or decompression (codec) module 926. This module 926 may have a MV binner unit 935 with a reference frame binning unit 938 and a hint module 936. The graphics module 935 also may store reference frame binning list(s) 912. The graphics processing unit, CPU, or other unit also may have a cache manager 928, L1 cache 930, L2 cache 932, and other caches L# 934. These components provide many of the functions described herein, and as explained with the processes described herein.

As will be appreciated, the modules illustrated in FIG. 9 may include a variety of software and/or hardware modules and/or modules that may be implemented via software or hardware or combinations thereof. For example, the modules may be implemented as software via processing units 902 or the modules may be implemented via a dedicated hardware portion on CPU(s) 906 or GPU(s) 908. Furthermore, the memory stores 910 may be shared memory for processing units 902, for example. The graphics buffer 914 may include reference frames 916, motion vector data 918, and other graphics data 920 stored on DDR DRAM remote from the L2 cache on the processors 906 or 908 by one example, or may be stored elsewhere. Also, system 900 may be implemented in a variety of ways. For example, system 900 (excluding display device 950) may be implemented as a single chip or device having a graphics processor, a quad-core central processing unit, and/or a memory controller input/output (I/O) module. In other examples, system 900 (again excluding display device 950) may be implemented as a chipset.

Processor(s) 906 may include any suitable implementation including, for example, microprocessor(s), multicore processors, application specific integrated circuits, chip(s), chipsets, programmable logic devices, graphics cards, integrated graphics, general purpose graphics processing unit(s), or the like. In addition, memory stores 910 may be any type of memory such as volatile memory (e.g., Static Random Access Memory (SRAM), Dynamic Random Access Memory (DRAM), etc.) or non-volatile memory (e.g., flash memory, etc.), and so forth. In a non-limiting example, memory stores 910 also may be implemented via cache memory in addition to the L2 cache 932. In various examples, system 900 may be implemented as a chipset or as a system on a chip.

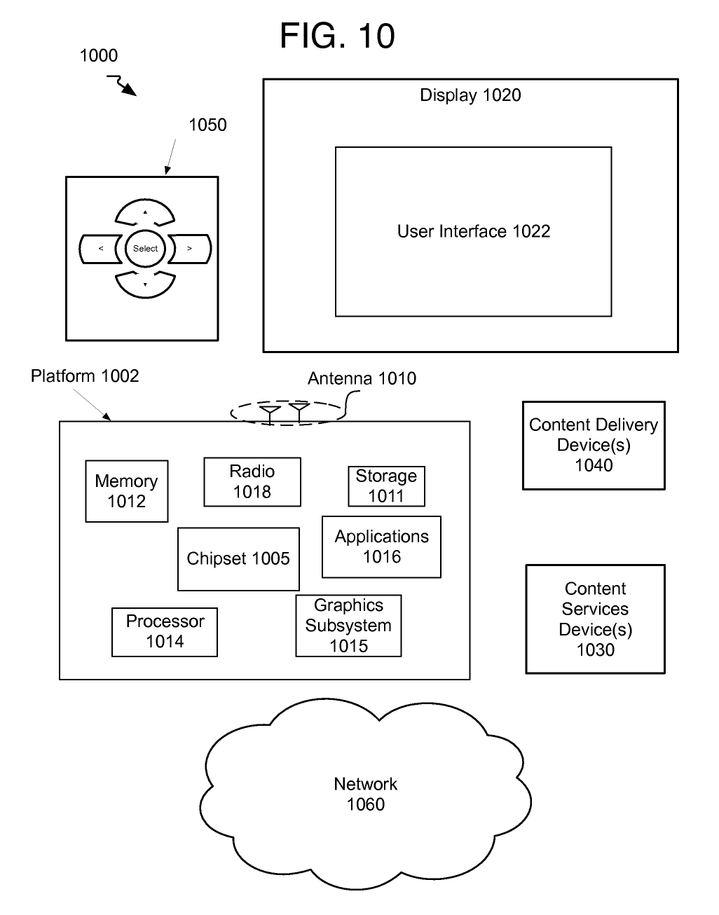

Referring to FIG. 10, an example system 1000 in accordance with the present disclosure and various implementations, may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1000 includes a platform 1002 communicatively coupled to a display 1020. Platform 1002 may receive content from a content device such as content services device(s) 1030 or content delivery device(s) 1040 or other similar content sources. A navigation controller 1050 including one or more navigation features may be used to interact with, for example, platform 1002 and/or display 1020. Each of these components is described in greater detail below.

In various implementations, platform 1002 may include any combination of a chipset 1005, processor 1014, memory 1012, storage 1011, graphics subsystem 1015, applications 1016 and/or radio 1018 as well as antenna(s) 1010. Chipset 1005 may provide intercommunication among processor 1014, memory 1012, storage 1011, graphics subsystem 1015, applications 1016 and/or radio 1018. For example, chipset 1005 may include a storage adapter (not depicted) capable of providing intercommunication with storage 1011.

Processor 1014 may be implemented as a Complex Instruction Set Computer (CISC) or Reduced Instruction Set Computer (RISC) processors; x86 instruction set compatible processors, multi-core, or any other microprocessor or central processing unit (CPU). In various implementations, processor 1014 may be dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1011 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1014 may include technology to increase the storage performance enhanced protection for valuable digital media when multiple hard drives are included, for example.

Graphics subsystem 1015 may perform processing of images such as still or video for display. Graphics subsystem 1015 may be a graphics processing unit (GPU) or a visual processing unit (VPU), for example. An analog or digital interface may be used to communicatively couple graphics subsystem 1015 and display 1020. For example, the interface may be any of a High-Definition Multimedia Interface, Display Port, wireless HDMI, and/or wireless HD compliant techniques. Graphics subsystem 1015 may be integrated into processor 1014 or chipset 1005. In some implementations, graphics subsystem 1015 may be a stand-alone card communicatively coupled to chipset 1005.

The graphics and/or video processing techniques described herein may be implemented in various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In other implementations, the functions may be implemented in a consumer electronics device.

Radio 1018 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In various implementations, display 1020 may include any television type monitor or display. Display 1020 may include, for example, a computer display screen, touch screen display, video monitor, television-like device, and/or a television. Display 1020 may be digital and/or analog. In various implementations, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In various implementations, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In various implementations, content services device(s) 1030 may include a cable television box, personal computer, network, telephone, Internet enabled devices or appliance capable of delivering digital information and/or content, and any other similar device capable of unidirectionally or bidirectionally communicating content between content providers and platform 1002 and/display 1020, via network 1060 or directly. It will be appreciated that the content may be communicated unidirectionally and/or bidirectionally to and from any one of the components in system 1000 and a content provider via network 1060. Examples of content may include any media information including, for example, video, music, medical and gaming information, and so forth.

Content services device(s) 1030 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1002 may receive control signals from navigation controller 1050 having one or more navigation features. The navigation features of controller 1050 may be used to interact with user interface 1022, for example. In implementations, navigation controller 1050 may be a pointing device that may be a computer hardware component (specifically, a human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1050 may be replicated on a display (e.g., display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022, for example. In implementations, controller 1050 may not be a separate component but may be integrated into platform 1002 and/or display 1020. The present disclosure, however, is not limited to the elements or in the context shown or described herein.

In various implementations, drivers (not shown) may include technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 even when the platform is turned “off.” In addition, chipset 1005 may include hardware and/or software support for 7.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various implementations, platform 1002 and display 1020 may be an integrated unit. Display 1020 and content service device(s) 1030 may be integrated, or display 1020 and content delivery device(s) 1040 may be integrated, for example. These examples are not meant to limit the present disclosure.

In various implementations, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 10.

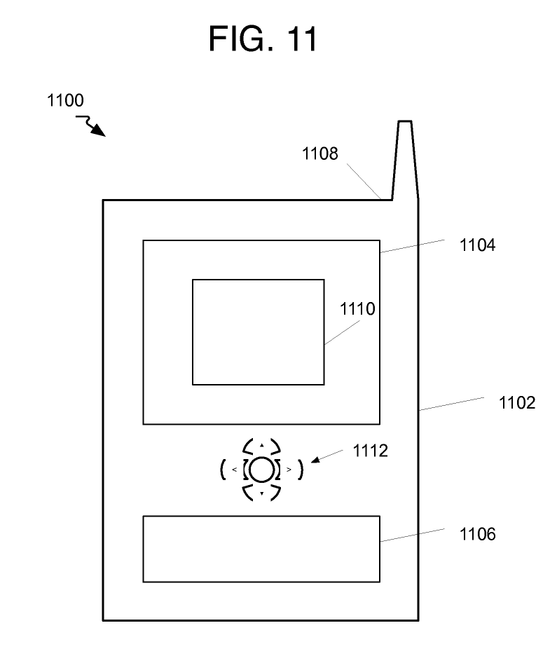

As described above, system 900 or 1000 may be implemented in varying physical styles or form factors. FIG. 11 illustrates implementations of a small form factor device 1100 in which system 900 or 1000 may be implemented. In implementations, for example, device 1100 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile computing devices as well. The implementations are not limited in this context.

As shown in FIG. 11, device 1100 may include a housing 1102, a display 1104, an input/output (I/O) device 1106, and an antenna 1108. Device 1100 also may include navigation features 1112. Display 1104 may include any suitable screen 1110 on a display unit for displaying information appropriate for a mobile computing device. I/O device 1106 may include any suitable I/O device for entering information into a mobile computing device. Examples for I/O device 1106 may include an alphanumeric keyboard, a numeric keypad, a touch pad, input keys, buttons, switches, rocker switches, microphones, speakers, voice recognition device and software, and so forth. Information also may be entered into device 1100 by way of microphone (not shown). Such information may be digitized by a voice recognition device (not shown). The implementations are not limited in this context.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects described above may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, which are apparent to persons skilled in the art to which the present disclosure pertains are deemed to lie within the spirit and scope of the present disclosure.

The following examples pertain to additional implementations.

By one example, a computer-implemented method of adaptive reference frame aching for video coding comprises receiving image data comprising frames and motion vector data; using the motion vector data to determine which frames are reference frames for an individual frame being reconstructed; modifying a binning count of the frequency individual frames are used as reference frames; and placing reference frame(s) in cache memory depending, at least in part, on the binning count.

By another implementation, the method may comprise wherein modifying the binning count comprises modifying a count in bins on at least one reference frame binning table where each bin comprises a count of the number of times a frame in a video sequence formed by the frames is used as a reference frame for another frame in the video sequence, wherein the binning table(s) comprises bins for a number of frames before the individual frame being reconstructed, after the individual frame being reconstructed, or both; wherein modifying the binning count comprises using two binning tables comprising a first binning table of 16 bins associated with 16 frames before the individual frame in the video sequence, and a second binning table of 16 bins associated with 16 frames after the individual frame in the video sequence.

The method also may comprise obtaining the motion vectors before pixel coding of a current frame occurs to provide a binning count and reference frames in cache to be used to reconstruct the current frame; obtaining the motion vectors after pixel coding of the individual frame to provide a binning count and reference frames in cache to be used to reconstruct a next frame; and identifying a number of the most frequently used frames and of the binning count as references frames to place the identified reference frames in cache, wherein one or two most frequently used reference frames are placed in cache.

The method also comprises that wherein placing comprises placing the reference frames in L2 cache; wherein modifying the binning count comprises modifying the count based on identification of the reference frames by motion vector regardless of which memory the reference frame is obtained from; and the method comprising placing the reference frames in cache according to the binning count depending on either: (1) the number of reference frames to be used for a single frame reconstruction, or (2) whether a cache hit count meets a criterion; or both.

By yet another implementation, a computer-implemented system has a at least one display; at least one cache memory; at least one other memory to receive image data comprising frames and motion vector data; at least one processor communicatively coupled to the memories and display; and at least one motion vector binning unit operated by the at least one processor and being arranged to: use the motion vector data to determine which frames are reference frames for an individual frame being reconstructed; modify a binning count of the frequency individual frames are used as reference frames; and indicate which reference frame(s) are to be placed in cache memory depending, at least in part, on the binning count.

By another implementation, the system may also comprise wherein modify a binning count comprises modifying a count in bins on at least one reference frame binning table where each bin comprises a count of the number of times a frame in a video sequence formed by the frames is used as a reference frame for another frame in the video sequence, wherein the binning table(s) comprises bins for a number of frames before the individual frame being reconstructed, after the individual frame being reconstructed, or both; wherein modify a binning count comprises using two binning tables comprising a first binning table of 16 bins associated with 16 frames before the individual frame in the video sequence, and a second binning table of 16 bins associated with 16 frames after the individual frame in the video sequence.

The at least one motion vector binning unit may be arranged to: obtain the motion vectors before pixel coding of a current frame occurs to provide a binning count and reference frames in cache to be used to reconstruct the current frame; obtain the motion vectors after pixel coding of the individual frame to provide a binning count and reference frames in cache to be used to reconstruct a next frame; and identify a number of the most frequently used frames and of the binning count as references frames to place the identified reference frames in cache, wherein one or two most frequently used reference frames are placed in cache; wherein the reference frames are to be placed in L2 cache; and wherein modify a binning count comprises modifying the count based on identification of the reference frames by motion vector regardless of which memory the reference frame is obtained from. The at least one motion vector binning unit may be arranged to place the reference frames in cache according to the binning count depending on either: (1) the number of reference frames to be used for a single frame reconstruction, or (2) whether a cache hit count meets a criterion; or both.

By one approach, at least one computer readable medium has stored thereon instructions that when executed cause a computing device to: receive image data comprising frames and motion vector data; use the motion vector data to determine which frames are reference frames for an individual frame being reconstructed; modify a binning count of the frequency individual frames are used as reference frames; and place reference frame(s) in cache memory depending, at least in part, on the binning count.

By another implementation, the instructions may include that wherein modify a binning count comprises modifying a count in bins on at least one reference frame binning table where each bin comprises a count of the number of times a frame in a video sequence formed by the frames is used as a reference frame for another frame in the video sequence, wherein the binning table(s) comprises bins for a number of frames before the individual frame being reconstructed, after the individual frame being reconstructed, or both; wherein modify a binning count comprises using two binning tables comprising a first binning table of 16 bins associated with 16 frames before the individual frame in the video sequence, and a second binning table of 16 bins associated with 16 frames after the individual frame in the video sequence.

The instructions causing the computing device to: obtain the motion vectors before pixel coding of a current frame occurs to provide a binning count and reference frames in cache to be used to reconstruct the current frame; obtain the motion vectors after pixel coding of the individual frame to provide a binning count and reference frames in cache to be used to reconstruct a next frame; identify a number of the most frequently used frames and of the binning count as references frames to place the identified reference frames in cache, wherein one or two most frequently used reference frames are placed in cache; wherein the reference frames are to be placed in L2 cache; and wherein modify a binning count comprises modifying the count based on identification of the reference frames by motion vector regardless of which memory the reference frame is obtained from. The instructions causing the computing device to place the reference frames in cache according to the binning count depending on either: (1) the number of reference frames to be used for a single frame reconstruction, or (2) whether a cache hit count meets a criterion; or both.

In another example, at least one machine readable medium may include a plurality of instructions that in response to being executed on a computing device, cause the computing device to perform the method according to any one of the above examples.

In yet another example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to the example methods may be implemented with respect to the example apparatus, the example systems, and/or the example articles, and vice versa.

What is claimed is:

1. A computer-implemented method of adaptive reference frame caching for video coding comprising:
receiving image data comprising frames and motion vector data;
using the motion vector data to determine which frames are reference frames for an individual frame being reconstructed;
modifying a binning count of the frequency individual frames are used as reference frames; and
placing reference frame(s) in cache memory depending, at least in part, on the binning count.

2. The method of claim 1 wherein modifying the binning count comprises modifying a count in bins on at least one reference frame binning table where each bin comprises a count of the number of times a frame in a video sequence formed by the frames is used as a reference frame for another frame in the video sequence.

3. The method of claim 2 wherein the binning table(s) comprises bins for a number of frames before the individual frame being reconstructed, after the individual frame being reconstructed, or both.

4. The method of claim 3 wherein modifying the binning count comprises using one binning table of 32 fields or
two binning tables comprising a first binning table of 16 bins associated with 16 frames before the individual frame in the video sequence, and a second binning table of 16 bins associated with 16 frames after the individual frame in the video sequence.

5. The method of claim 1 comprising obtaining the motion vectors before pixel coding of a current frame occurs to provide a binning count and reference frames in cache to be used to reconstruct the current frame.

6. The method of claim 1 comprising obtaining the motion vectors after pixel coding of the individual frame to provide a binning count and reference frames in cache to be used to reconstruct a next frame.

7. The method of claim 1 comprising identifying a number of the most frequently used frames and of the binning count as references frames to place the identified reference frames in cache.

8. The method of claim 7 wherein one or two most frequently used reference frames are placed in cache.

9. The method of claim 1 wherein placing comprises placing the reference frames in L2 cache.

10. The method of claim 1 wherein modifying the binning count comprises modifying the count based on identification of the reference frames by motion vector regardless of which memory the reference frame is obtained from.

11. The method of claim 1 comprising placing the reference frames in cache according to the binning count depending on either:
(1) the number of reference frames to be used for a single frame reconstruction, or
(2) whether a cache hit count meets a criterion; or
both.

12. The method of claim 1 wherein modifying the binning count comprises modifying a count in bins on at least one reference frame binning table where each bin comprises a count of the number of times a frame in a video sequence formed by the frames is used as a reference frame for another frame in the video sequence, wherein the binning table(s) comprises bins for a number of frames before the individual frame being reconstructed, after the individual frame being reconstructed, or both;
wherein modifying the binning count comprises using one binning table of 32 fields or two binning tables comprising a first binning table of 16 bins associated with 16 frames before the individual frame in the video sequence, and a second binning table of 16 bins associated with 16 frames after the individual frame in the video sequence;
the method comprising:
obtaining the motion vectors before pixel coding of a current frame occurs to provide a binning count and reference frames in cache to be used to reconstruct the current frame;
obtaining the motion vectors after pixel coding of the individual frame to provide a binning count and reference frames in cache to be used to reconstruct a next frame;
identifying a number of the most frequently used frames and of the binning count as references frames to place the identified reference frames in cache, wherein one or two most frequently used reference frames are placed in cache;
wherein placing comprises placing the reference frames in L2 cache;
wherein modifying the binning count comprises modifying the count based on identification of the reference frames by motion vector regardless of which memory the reference frame is obtained from;
comprising placing the reference frames in cache according to the binning count depending on either:
(1) the number of reference frames to be used for a single frame reconstruction, or
(2) whether a cache hit count meets a criterion; or
both.

13. A computer-implemented system comprising:
at least one display;
at least one cache memory;
at least one other memory to receive image data comprising frames and motion vector data;
at least one processor communicatively coupled to the memories and display; and
at least one motion vector binning unit operated by the at least one processor and being arranged to:
use the motion vector data to determine which frames are reference frames for an individual frame being reconstructed;
modify a binning count of the frequency individual frames are used as reference frames; and
indicate which reference frame(s) are to be placed in cache memory depending, at least in part, on the binning count.

14. The system of claim 13 wherein modifying the binning count comprises modifying a count in bins on at least one reference frame binning table where each bin comprises a count of the number of times a frame in a video sequence formed by the frames is used as a reference frame for another frame in the video sequence.

15. The system of claim 14 wherein the binning table(s) comprises bins for a number of frames before the individual frame being reconstructed, after the individual frame being reconstructed, or both.

16. The system of claim 15 wherein modify a binning count comprises using one binning table of 32 fields or
two binning tables comprising a first binning table of 16 bins associated with 16 frames before the individual frame in the video sequence, and a second binning table of 16 bins associated with 16 frames after the individual frame in the video sequence.

17. The system of claim 13 wherein the motion vector binning unit is to obtain the motion vectors before pixel coding of a current frame occurs to provide a binning count and reference frames in cache to be used to reconstruct the current frame.

18. The system of claim 13 wherein the motion vector binning unit is to obtain the motion vectors after pixel coding of the individual frame to provide a binning count and reference frames in cache to be used to reconstruct a next frame.

19. The system of claim 13 wherein the motion vector binning unit is to identify a number of the most frequently used frames and of the binning count as references frames to place the identified reference frames in cache.

20. The system of claim 19 wherein one or two most frequently used reference frames are placed in cache.

21. The system of claim 13 wherein the reference frames are to be placed in L2 cache.

22. The system of claim 13 wherein modify a binning count comprises modifying the count based on identification of the reference frames by motion vector regardless of which memory the reference frame is obtained from.

23. The system of claim 13 wherein modify a binning count comprises modifying a count in bins on at least one reference frame binning table where each bin comprises a count of the number of times a frame in a video sequence formed by the frames is used as a reference frame for another frame in the video sequence, wherein the binning table(s) comprises bins for a number of frames before the individual frame being reconstructed, after the individual frame being reconstructed, or both;
wherein modify a binning count comprises using one binning table of 32 fields or two binning tables comprising a first binning table of 16 bins associated with 16 frames before the individual frame in the video sequence, and a second binning table of 16 bins associated with 16 frames after the individual frame in the video sequence;
the at least one motion vector binning unit being arranged to:
obtain the motion vectors before pixel coding of a current frame occurs to provide a binning count and reference frames in cache to be used to reconstruct the current frame;
obtain the motion vectors after pixel coding of the individual frame to provide a binning count and reference frames in cache to be used to reconstruct a next frame;
identify a number of the most frequently used frames and of the binning count as references frames to place the identified reference frames in cache, wherein one or two most frequently used reference frames are placed in cache;
wherein the reference frames are to be placed in L2 cache;
wherein modify a binning count comprises modifying the count based on identification of the reference frames by motion vector regardless of which memory the reference frame is obtained from;
the at least one motion vector binning unit is arranged to place the reference frames in cache according to the binning count depending on either:
(1) the number of reference frames to be used for a single frame reconstruction, or
(2) whether a cache hit count meets a criterion; or
both.

24. At least one computer-readable medium having stored thereon instructions that when executed cause a computing device to:
receive image data comprising frames and motion vector data;
use the motion vector data to determine which frames are reference frames for an individual frame being reconstructed;
modify a binning count of the frequency individual frames are used as reference frames; and
place reference frame(s) in cache memory depending, at least in part, on the binning count.

25. The computer-readable medium of claim 24 wherein modify a binning count comprises modifying a count in bins on at least one reference frame binning table where each bin comprises a count of the number of times a frame in a video sequence formed by the frames is used as a reference frame for another frame in the video sequence, wherein the binning table(s) comprises bins for a number of frames before the individual frame being reconstructed, after the individual frame being reconstructed, or both;
wherein modify a binning count comprises using one binning table of 32 fields or two binning tables comprising a first binning table of 16 bins associated with 16 frames before the individual frame in the video sequence, and a second binning table of 16 bins associated with 16 frames after the individual frame in the video sequence;
the instructions causing the computing device to:
obtain the motion vectors before pixel coding of a current frame occurs to provide a binning count and reference frames in cache to be used to reconstruct the current frame;
obtain the motion vectors after pixel coding of the individual frame to provide a binning count and reference frames in cache to be used to reconstruct a next frame;
identify a number of the most frequently used frames and of the binning count as references frames to place the identified reference frames in cache, wherein one or two most frequently used reference frames are placed in cache;
wherein the reference frames are to be placed in L2 cache;
wherein modify a binning count comprises modifying the count based on identification of the reference frames by motion vector regardless of which memory the reference frame is obtained from;
the instructions causing the computing device to place the reference frames in cache according to the binning count depending on either:
(1) the number of reference frames to be used for a single frame reconstruction, or
(2) whether a cache hit count meets a criterion; or
both.
